(19) United States
(12) Patent Application Publication
(10) Pub. No.: US 2026/0256207 A1
(43) Pub. Date: Sep. 3, 2026

(54) CONTROL METHOD, AND AEROSOL GENERATING DEVICE FOR PERFORMING SAME METHOD

(71) Applicant: KT&G CORPORATION, Daejeon (KR)

(72) Inventor: Dong Sung KIM, Seoul (KR)

(73) Assignee: KT&G CORPORATION, Daejeon (KR)

(21) Appl. No.: 19/159,584

(22) PCT Filed: Jun. 7, 2024
(86) PCT No.: PCT/KR2024/007771

§ 371 Date: Aug. 25, 2025

(30) Foreign Application Priority Data
Aug. 14, 2023 (KR) 10-2023-0106227

(51) Int. Cl. A24F 40/51; A24F 40/10; A24F 40/42; A24F 40/46; A24F 40/53; A24F 40/57; G01N 27/07; G01N 27/22

(52) U.S. Cl. CPC A24F 40/51; A24F 40/42; A24F 40/46; A24F 40/53; A24F 40/57; G01N 27/07; G01N 27/226; A24F 40/10

(57) ABSTRACT

An aerosol generating device, according to one embodiment, comprises: a detection circuit including a first electrode circuit and a second electrode circuit that are arranged so as not to be electrically connected to each other inside a receiving space into which an aerosol generating article is inserted; a heater that heats the aerosol generating article; a control unit; and a power supply unit that supplies power to the control unit, wherein the control unit can determine a target type of the aerosol generating article on the basis of an electrical characteristic of the detection circuit that is exhibited when the first electrode circuit and the second electrode circuit are electrically connected by means of the aerosol generating article as the aerosol generating article is inserted into the receiving space, and control the power supplied to the heater on the basis of the target type of the aerosol generating article.

### TECHNICAL FIELD

The following description relates to technology for generating an aerosol, and more particularly, to technology for providing an appropriate temperature profile according to a type of aerosol generating article.

### BACKGROUND ART

Recently, the demand for electronic cigarette devices has increased. The rising demand for electronic cigarettes has accelerated the continued development of functions related to electronic cigarette devices. The functions may include, in particular, functions according to the types and characteristics of electronic cigarette devices.

An aerosol generating article may be heated using a heating profile appropriate for each of various types to provide a user with an optimal smoking sensation and taste. The aerosol generating article may generate an aerosol based on a user input regarding a heating method or a type of aerosol generating article. Various methods may be provided to recognize an aerosol generating article even when there is no user input.

### DISCLOSURE OF THE INVENTION

### Technical Goals

The present disclosure solve the above-mentioned and other issues.

An embodiment may provide a method and device for determining a type of aerosol generating article.

An embodiment may provide a method and device for controlling power supplied to a heater based on a type of aerosol generating article.

### Technical Solutions

An aerosol generating device according to an embodiment includes a detection circuit including a first electrode circuit and a second electrode circuit arranged not to be electrically connected to each other inside a receiving space, into which an aerosol generating article is inserted, a heater configured to heat the aerosol generating article, a controller, and a power supply unit configured to supply power to the controller, wherein the controller may be configured to perform determining a target type of the aerosol generating article based on an electrical characteristic of the detection circuit that is present when the first electrode circuit and the second electrode circuit are electrically connected by the aerosol generating article as the aerosol generating article is inserted into the receiving space, and controlling power supplied to the heater based on the target type of the aerosol generating article.

A control method of an aerosol generating device according to an embodiment, being performed by the aerosol generating device, wherein the aerosol generating device includes a detection circuit including a first electrode circuit and a second electrode circuit arranged not to be electrically connected to each other inside a receiving space, into which an aerosol generating article is inserted, a heater configured to heat the aerosol generating article, a controller, and a power supply unit configured to supply power to the controller, may include determining a target type of the aerosol generating article based on an electrical characteristic of the detection circuit that is present when the first electrode circuit and the second electrode circuit are electrically connected to each other by the aerosol generating article as the aerosol generating article is inserted into the receiving space, and controlling power supplied to the heater based on the target type of the aerosol generating article.

An aerosol generating device according to an embodiment includes a detection circuit comprising a first electrode circuit and a second electrode circuit arranged not to be electrically connected to each other inside a receiving space into which an aerosol generating article is inserted, a heater configured to heat the aerosol generating article, a controller, and a power supply unit configured to supply power to the controller, wherein, when the first electrode circuit and the second electrode circuit are electrically connected to each other by the aerosol generating article as the aerosol generating article is inserted into the receiving space, the controller may be configured to receive power from the power supply unit and the aerosol generating device may be configured to be powered on.

### Effects of the Invention

According to at least one of the embodiments of the present disclosure, an appropriate heating profile may be selected according to a type of aerosol generating article.

### BRIEF DESCRIPTION OF DRAWINGS

FIGS. 1A to 1D are diagrams illustrating examples of an aerosol generating article inserted into an aerosol generating device, according to various embodiments.

FIGS. 2 and 3 are diagrams illustrating examples of an aerosol generating article, according to various embodiments.

FIG. 4 is a block diagram illustrating an aerosol generating device according to various embodiments.

FIG. 5 is a flowchart illustrating a control method of an aerosol generating device, according to various embodiments.

FIG. 6 is a diagram illustrating a conductive material of an aerosol generating article, according to an embodiment.

FIG. 7 is a diagram illustrating a detection circuit of an aerosol generating device, according to an embodiment.

FIG. 8 is a diagram illustrating an operation of an aerosol generating device, according to an embodiment.

### BEST MODE FOR CARRYING OUT THE INVENTION

The following detailed structural or functional description is provided as an example only and various alterations and modifications may be made to embodiments. Thus, an actual form of implementation is not construed as limited to the embodiments described herein and should be understood to include all changes, equivalents, and replacements within the idea and the technical scope of the disclosure.

Although terms, such as first, second, and the like are used to describe various components, the components are not limited to the terms. These terms should be used only to distinguish one component from another component. For example, a first component may be referred to as a second component, and similarly, the second component may also be referred to as the first component.

It should be noted that when one component is described as being “connected” to another component, the first component may be directly connected or coupled to the second component, or a third component may exist between the first and second components.

The singular forms are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, the embodiments are described in detail with reference to the accompanying drawings. When describing the embodiments with reference to the accompanying drawings, like reference numerals refer to like components and a repeated description related thereto is omitted.

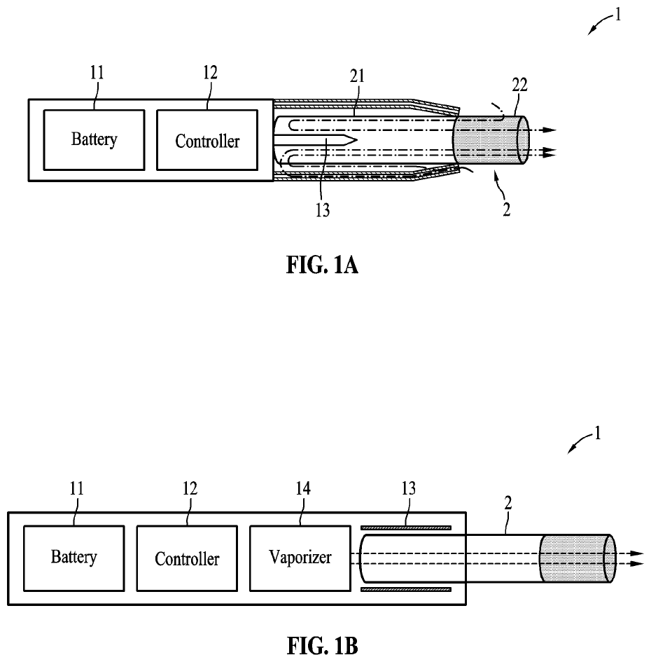

FIGS. 1A to 1D are diagrams illustrating examples of an aerosol generating article inserted into an aerosol generating device, according to various embodiments.

Referring to FIG. 1A, an aerosol generating device 1 includes a battery 11, a controller 12, and a heater 13. Referring to FIGS. 1B and 1C, the aerosol generating device 1 further includes a vaporizer 14. Referring to FIG. 1D, the aerosol generating device 1 includes a battery 11, a controller 12, a coil 13a, and a susceptor 13b. In addition, a cigarette 2 may be inserted into an inner space of the aerosol generating device 1.

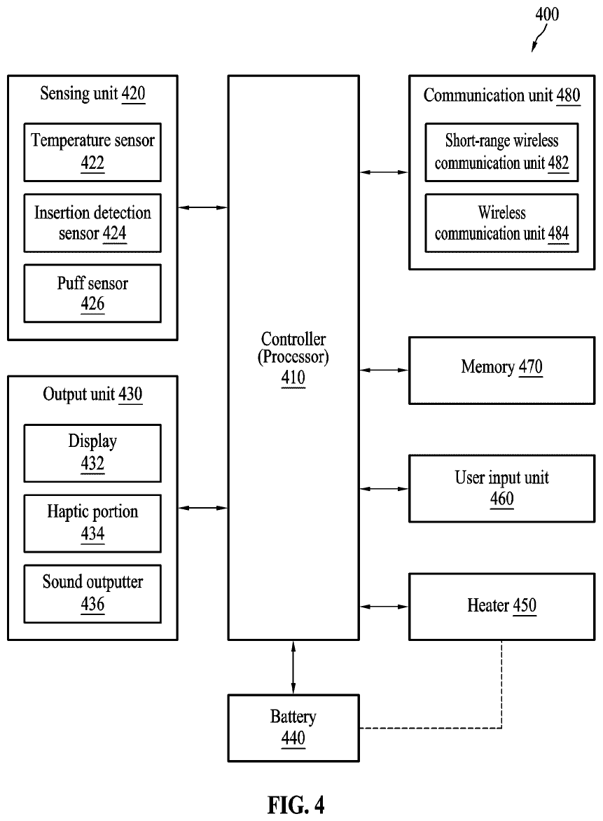

The aerosol generating device 1 illustrated in FIGS. 1A to 1D (or an aerosol generating device 400 illustrated in FIG. 4) illustrates components related to the present embodiment. Therefore, it is to be understood by those having ordinary skill in the art to which the present embodiment pertains that the aerosol generating device 1 (or the aerosol generating device 400) may further include other generally used components in addition to the components illustrated in FIGS. 1A to 1D (or FIG. 4).

In addition, although it is shown that the heater 13 is included in the aerosol generating device 1 in FIGS. 1B and 1C, the heater 13 may be omitted as needed. For example, the aerosol generating device 1 that does not include the heater 13 may generate an aerosol through the vaporizer 14.

FIG. 1A illustrates the battery 11, the controller 12, and the heater 13 arranged in a row. In addition, FIG. 1B illustrates the battery 11, the controller 12, the vaporizer 14, and the heater 13 arranged in a row. In addition, FIG. 1C illustrates the vaporizer 14 and the heater 13 arranged in parallel. However, the internal structure of the aerosol generating device 1 is not limited to what is shown in FIGS. 1A to 1C. That is, the arrangement of the battery 11, the controller 12, the heater 13, and the vaporizer 14 may be changed depending on a design of the aerosol generating device 1.

When the cigarette 2 is inserted into the aerosol generating device 1, the aerosol generating device 1 may actuate the heater 13 and/or the vaporizer 14 to generate an aerosol. The aerosol generated by the heater 13 and/or the vaporizer 14 may pass through the cigarette 2 into a user.

Even when the cigarette 2 is not inserted into the aerosol generating device 1, the aerosol generating device 1 may heat the heater 13, as needed.

The battery 11 may supply power to be used to operate the aerosol generating device 1. For example, the battery 11 may supply power to heat the heater 13 or the vaporizer 14 and may supply power required for the controller 12 to operate. In addition, the battery 11 may supply power required to operate a display, a sensor, a motor, or the like installed in the aerosol generating device 1.

The controller 12 may control the overall operation of the aerosol generating device 1. Specifically, the controller 12 may control respective operations of other components included in the aerosol generating device 1 in addition to the battery 11, the heater 13, and the vaporizer 14. In addition, the controller 12 may verify a state of each of the components of the aerosol generating device 1 to determine whether the aerosol generating device 1 is in an operable state.

The controller 12 may include at least one processor. The processor may be implemented as an array of a plurality of logic gates or as a combination of a general-purpose microprocessor and a memory in which a program executable by the microprocessor is stored. In addition, it is to be understood by one of ordinary skill in the art to which the present embodiment pertains that the processor may be implemented in other types of hardware.

The heater 13 may be heated by power supplied by the battery 11. For example, when the cigarette 2 is inserted into the aerosol generating device 1, the heater 13 may be outside the cigarette 2. Thus, the heated heater 13 may raise a temperature of an aerosol generating material in the cigarette 2.

The heater 13 may be an electrically resistive heater. For example, the heater 13 may include an electrically conductive track, and the heater 13 may be heated as a current flows through the electrically conductive track. However, the heater 13 is not limited to the above-described example, and any example of heating the heater 13 up to a desired temperature may be applicable without limitation. The desired temperature may be preset in the aerosol generating device 1 or may be set by the user.

In addition, in another example, the heater 13 may be an induction heating heater including the coil 13a and the susceptor 13b as shown in FIG. 1D. Therefore, redundant descriptions of the heater 13 are omitted.

Specifically, the aerosol generating device 1 may include the electrically conductive coil 13a for heating the cigarette 2 in an induction heating manner and the susceptor 13b to be heated by the induction heating heater. Although not shown in FIG. 1D, the susceptor 13b may be included in the cigarette 2 rather than in the aerosol generating device 1.

For example, the heater 13 may include a tubular heating element, a plate-shaped heating element, a needle-shaped heating element, or a rod-shaped heating element and may heat an inside or outside of the cigarette 2 according to the shape of a heating element.

In addition, the heater 13 may be provided as a plurality of heaters in the aerosol generating device 1. In this case, the plurality of heaters 13 may be disposed to be inserted into the cigarette 2 or may be placed outside the cigarette 2. In addition, some of the plurality of heaters 13 may be placed to be inserted into the cigarette 2, and the rest may be placed outside the cigarette 2. In addition, the shape of the heater 13 is not limited to the shape shown in FIGS. 1A to 1D and may be manufactured in various shapes.

The vaporizer 14 may heat a liquid composition to generate an aerosol, and the generated aerosol may pass through the cigarette 2 into the user. That is, the aerosol generated by the vaporizer 14 may travel along an airflow path of the aerosol generating device 1, and the airflow path may be configured so that the aerosol generated by the vaporizer 14 may pass through the cigarette 2 into the user.

For example, the vaporizer 14 may include a liquid storage, a liquid transfer means, and a heating element. However, embodiments are not limited thereto. For example, the liquid storage, the liquid transfer means, and the heating element may be included as independent modules in the aerosol generating device 1.

The liquid storage may store the liquid composition. The liquid composition may be, for example, a liquid including a tobacco-containing material that includes a volatile tobacco flavor component or a liquid including a non-tobacco material. The liquid storage may be manufactured to be detachably attached to the vaporizer 14 or may be manufactured in an integral form with the vaporizer 14.

The liquid composition may include, for example, water, a solvent, ethanol, a plant extract, a fragrance, a flavoring agent, or a vitamin mixture. The fragrance may include, for example, menthol, peppermint, spearmint oil, various fruit-flavored ingredients, and the like. However, embodiments are not limited thereto. The flavoring agent may include ingredients that provide the user with a variety of flavors or scents. The vitamin mixture may be a mixture of at least one of vitamin A, vitamin B, vitamin C, or vitamin E. However, embodiments are not limited thereto. The liquid composition may also include an aerosol former such as glycerin and propylene glycol.

The liquid transfer means may transfer the liquid composition in the liquid storage to the heating element. The liquid transfer means may be, for example, a wick such as cotton fiber, ceramic fiber, glass fiber, or porous ceramic. However, embodiments are not limited thereto.

The heating element may be an element configured to heat the liquid composition transferred by the liquid transfer means. The heating element may be, for example, a metal heating wire, a metal heating plate, a ceramic heater, or the like. However, embodiments are not limited thereto. In addition, the heating element may include a conductive filament such as a nichrome wire and may be arranged in a structure wound around the liquid transfer means. The heating element may be heated as a current is supplied and may transfer heat to the liquid composition in contact with the heating element, thereby heating the liquid composition. As a result, an aerosol may be generated.

For example, the vaporizer 14 may also be referred to as a cartomizer or an atomizer. However, embodiments are not limited thereto.

The aerosol generating device 1 may further include general-purpose components in addition to the battery 11, the controller 12, the heater 13, and the vaporizer 14. For example, the aerosol generating device 1 may include a display capable of outputting visual information and/or a motor for outputting tactile information. In addition, the aerosol generating device 1 may include at least one sensor (e.g., a puff sensor, a temperature sensor, a cigarette insertion detection sensor, or the like). In addition, the aerosol generating device 1 may be manufactured to have a structure which external air may be introduced into or internal gas may be discharged from even when the cigarette 2 is inserted into the aerosol generating device 1.

Although not shown in FIGS. 1A to 1D, the aerosol generating device 1 may also be configured as a system together with a separate cradle. For example, the cradle may be used to charge the battery 11 of the aerosol generating device 1. Alternatively, the cradle may be used to heat the heater 13 in a state in which the cradle and the aerosol generating device 1 are coupled.

Referring to FIG. 1D, the aerosol generating device 1 may include the battery 11, the controller 12, the coil 13a, the susceptor 13b, and a cavity 13c.

The cigarette 2 may be inserted into the cavity 13c of the aerosol generating device 1, and the coil 13a may be positioned around the cavity 13c. In FIG. 1D, the coil 13a is illustrated as being placed to surround the cavity 13c. However, embodiments are not limited thereto.

The aerosol generating device 1 may generate an aerosol by heating the cigarette 2 in an induction heating manner. The induction heating manner may refer to a manner of generating heat from a magnetic material by applying an alternating magnetic field.

When the alternating magnetic field is applied to the magnetic material, an energy loss may occur in the magnetic material due to an eddy current loss and a hysteresis loss. The lost energy may be released from the magnetic material as heat energy. As an amplitude or a frequency of the alternating magnetic field increases, an amount of heat energy released from the magnetic material may increase. The magnetic material that generates heat by an external magnetic field may be a susceptor.

The aerosol generating device 1 may be provided with the susceptor 13b that generates heat by an external magnetic field. The aerosol generating device 1 may heat the cigarette 2 by applying an alternating magnetic field to the susceptor 13b.

The susceptor 13b may include metal or carbon. The susceptor 13b may include at least one of ferrite, a ferromagnetic alloy, stainless steel, or aluminum (Al).

In addition, the susceptor 13b may include at least one of a ceramic such as graphite, molybdenum, silicon carbide, niobium, a nickel alloy, a metal film, zirconia, a transition metal such as nickel (Ni) or cobalt (Co), or a metalloid such as boron (B) or phosphorus (P).

The aerosol generating device 1 may include the cavity 13c for accommodating the cigarette 2. The cavity 13c may include an opening that opens on the outside of the cavity 13c to accommodate the cigarette 2 in the aerosol generating device 1.

The aerosol generating device 1 may include the coil 13a that applies an alternating magnetic field to the susceptor 13b. The coil 13a may be wound along a side surface of the cavity 13c. The coil 13a may be placed near the susceptor 13b.

The coil 13a may receive power from the battery 11. As power is supplied to the coil 13a, a magnetic field may be formed inside the coil 13a. When an alternating current is applied to the coil 13a, the magnetic field formed inside the coil 13a may change direction periodically. When the susceptor 13b is exposed to the alternating magnetic field formed by the coil 13a, the susceptor 13b may generate heat, thereby heating the cigarette 2 accommodated in the aerosol generating device 1.

A temperature of the susceptor 13b that heats the cigarette 2 may change as the amplitude or the frequency of the alternating magnetic field formed by the coil 13a changes. The controller 12 may control the power supplied to the coil 13a to adjust the amplitude or the frequency of the alternating magnetic field formed by the coil 13a, and accordingly, the temperature of the susceptor 13b may be controlled.

For example, the coil 13a may be implemented as a solenoid. The coil 13a may be a solenoid wound along the side surface of the cavity 13c. The cigarette 2 may be accommodated in an inner space of the solenoid. The solenoid may include, but is not limited to, copper (Cu).

To allow high current to flow by having low resistivity, the solenoid may include one or an alloy including at least one of silver (Ag), gold (Au), aluminum (Al), tungsten (W), zinc (Zn), and nickel (Ni).

The cigarette 2 may be similar to a general combustion type cigarette. For example, the cigarette 2 may be divided into a first portion including an aerosol generating material and a second portion including a filter or the like. Alternatively, the second portion of the cigarette 2 may also include an aerosol generating material. For example, an aerosol generating material provided in a form of granules or capsules may be inserted into the second portion.

The first portion may be entirely inserted into the aerosol generating device 1, and the second portion may be exposed outside. Alternatively, only the first portion may be partially inserted into the aerosol generating device 1, or the first portion may be entirely inserted into the aerosol generating device 1 and the second portion may be partially inserted into the aerosol generating device 1. The user may inhale aerosol with the second portion in a mouth of the user. In this case, the aerosol may be generated as external air passes through the first portion, and the generated aerosol may pass through the second portion into the mouth of the user.

For example, the external air may be introduced through at least one air path formed in the aerosol generating device 1. For example, opening or closing of the air path formed in the aerosol generating device 1 and/or a size of the air path may be adjusted by the user. Accordingly, an amount of atomization, a sense of smoking, or the like may be adjusted by the user. In another example, the external air may be introduced into the inside of the cigarette 2 through at least one hole formed on a surface of the cigarette 2.

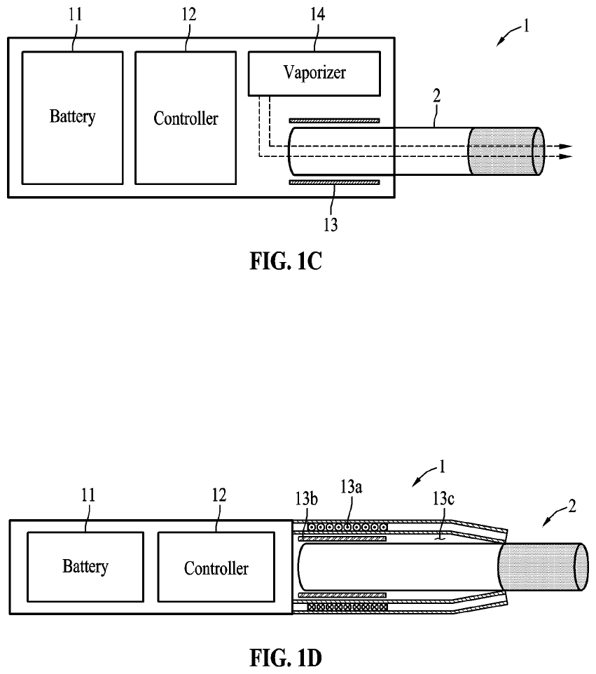

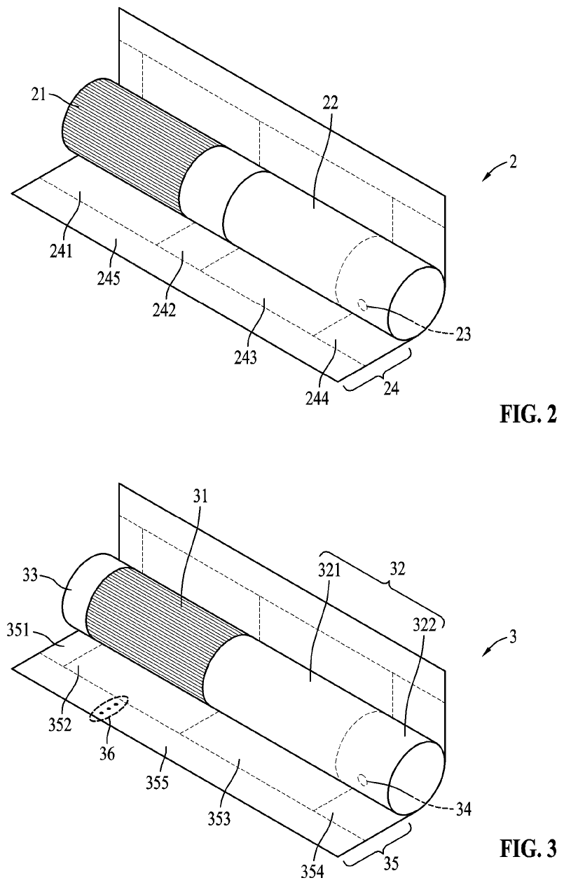

Hereinafter, examples of the cigarette 2 are described with reference to FIGS. 2 and 3.

FIGS. 2 and 3 are diagrams illustrating examples of a cigarette.

Referring to FIG. 2, the cigarette 2 includes a tobacco rod 21 and a filter rod 22. The first portion described above with reference to FIGS. 1A to 1D includes a tobacco rod 21, and the second portion includes a filter rod 22.

Although the filter rod 22 is illustrated as having a single segment in FIG. 4, embodiments are not limited thereto. That is, the filter rod 22 may include a plurality of segments. For example, the filter rod 22 may include a segment that cools an aerosol and a segment that filters a predetermined ingredient contained in aerosol. In addition, the filter rod 22 may further include at least one segment that performs another function, as needed.

A diameter of the cigarette 2 may be in a range of 5 millimeters (mm) to 9 mm, and a length thereof may be about 48 mm. However, embodiments are not limited thereto. For example, a length of the cigarette rod 21 may be about 12 mm, a length of a first segment of the filter rod 22 may be about 10 mm, a length of a second segment of the filter rod 22 may be about 14 mm, and a length of a third segment of the filter rod 22 may be about 12 mm. However, embodiments are not limited thereto.

The cigarette 2 may be wrapped with at least one wrapper 24. The wrapper 24 may have at least one hole formed therein through which external air may be introduced or internal gas may flow out. For example, the cigarette 2 may be wrapped with one wrapper 24. In another example, the cigarette 2 may be wrapped with two or more wrappers 24 in an overlapping manner. For example, the tobacco rod 21 may be wrapped with a first wrapper 241, and the filter rod 22 may be wrapped with wrappers 242, 243, and 244. In addition, the cigarette 2 may be entirely wrapped again with a fifth wrapper 255. For example, when the filter rod 22 includes a plurality of segments, the plurality of segments may be wrapped with the wrappers 242, 243, and 244, respectively.

The first wrapper 241 and the second wrapper 242 may be manufactured from general filter wrapping paper. For example, the first wrapper 241 and the second wrapper 242 may be porous wrapping paper or non-porous wrapping paper. In addition, the first wrapper 241 and the second wrapper 242 may be manufactured from oilproof paper and/or an aluminum laminated wrapping material.

The third wrapper 243 may be manufactured from hard wrapping paper. For example, a basis weight of the third wrapper 243 may be in a range of 88 grams per square meter (g/m2) to 96 g/m2 , and desirably, may be in a range of 90 g/m2 to 94 g/m2 . Furthermore, a thickness of the third wrapper 243 may be in a range of 120 micrometers (μm) to 130 μm, and desirably, may be 125 μm.

The fourth wrapper 244 may be manufactured from oilproof hard wrapping paper. For example, a basis weight of the fourth wrapper 244 may be in a range of 88 g/m2 to 96 g/m2, and desirably, may be in a range of 90 g/m2 to 94 g/m2. Furthermore, a thickness of the fourth wrapper 244 may be in a range of 120 μm to 130 μm, and desirably, may be 125 μm.

The fifth wrapper 245 may be manufactured from sterile paper (e.g., MFW). Here, the sterile paper (e.g., MFW) may refer to paper specially made such that the paper has enhanced tensile strength, water resistance, smoothness, or the like, compared to general paper. For example, a basis weight of the fifth wrapper 245 may be in a range of 57 g/m2 to 63 g/m2, and desirably, may be 60 g/m2. Furthermore, a thickness of the fifth wrapper 245 may be in a range of 64 μm to 70 μm, and desirably, may be 67 μm.

The fifth wrapper 245 may have a predetermined material internally added thereto. The predetermined material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not necessarily be used, and any material having such properties described above may be applied to (or used to coat) the fifth wrapper 245 without limitation.

The fifth wrapper 245 may prevent the cigarette 2 from burning. For example, there may be a probability that the cigarette 2 burns when the tobacco rod 21 is heated by the heater 13. For example, when the temperature rises above an ignition point of any one of materials included in the tobacco rod 21, the cigarette 2 may burn. Even in this case, it may still be possible to prevent the cigarette 2 from burning because the fifth wrapper 245 includes a non-combustible material.

In addition, the fifth wrapper 245 may prevent a holder from being contaminated by substances produced in the cigarette 2. Liquid substances may be produced in the cigarette 2 when a user puffs. For example, as an aerosol generated in the cigarette 2 is cooled by external air, liquid substances (e.g., water or the like) may be produced. Thus, wrapping the cigarette 2 with the fifth wrapper 245 may prevent the liquid substances produced in the cigarette 2 from leaking out of the cigarette 2.

The tobacco rod 21 includes an aerosol generating material. The aerosol generating material may include, for example, at least one of glycerin, propylene glycol, ethylene glycol, dipropylene glycol, diethylene glycol, triethylene glycol, tetraethylene glycol, or oleyl alcohol. However, embodiments are not limited thereto. The tobacco rod 21 may also include other additives such as a flavoring agent, a wetting agent, and/or an organic acid. In addition, the tobacco rod 21 may include a flavoring liquid such as menthol or a moisturizer that is added by being sprayed onto the tobacco rod 21.

The tobacco rod 21 may be manufactured in various forms. For example, the tobacco rod 21 may be manufactured as a sheet or a strand. The tobacco rod 21 may also be manufactured from tobacco leaves finely cut from a tobacco sheet. In addition, the tobacco rod 21 may be enveloped by a thermally conductive material. The thermally conductive material may be, for example, a metal foil such as an aluminum foil. However, embodiments are not limited thereto. For example, the thermally conductive material enveloping the tobacco rod 21 may evenly distribute the heat transferred to the tobacco rod 21 to improve the conductivity of the heat to be applied to the tobacco rod 21, thereby improving the taste of tobacco. In addition, the thermally conductive material enveloping the tobacco rod 21 may function as a susceptor heated by an induction heater. Here, although not shown in the drawings, the tobacco rod 21 may further include an additional susceptor in addition to the thermally conductive material enveloping the outside thereof.

The filter rod 22 may be a cellulose acetate filter. However, a shape of the filter rod 22 is not limited. For example, the filter rod 22 may be a cylindrical rod or a tubular rod including a hollow therein. The filter rod 22 may also be a recess-type rod. For example, when the filter rod 22 includes a plurality of segments, at least one of the plurality of segments may be manufactured in a different shape.

The first segment of the filter rod 22 may be a cellulose acetate filter. For example, the first segment may be a tubular structure including a hollow therein. The first segment may prevent internal materials of the tobacco rod 21 from being pushed back when the heater 13 is inserted and generate an effect of cooling the aerosol. A desirable diameter may be adopted as a diameter of the hollow included in the first segment, in a range of 2 mm to 4.5 mm. However, embodiments are not limited thereto.

A desirable length may be adopted as the length of the first segment, in a range of 4 mm to 30 mm. However, embodiments are not limited thereto. Desirably, the length of the first segment may be 10 mm. However, embodiments are not limited thereto.

A hardness of the first segment may be adjusted by adjusting a plasticizer content in a process of manufacturing the first segment. In addition, the first segment may be manufactured by inserting a structure such as a film or a tube of the same or different materials therein (e.g., in the hollow).

The second segment of the filter rod 22 may cool an aerosol generated as the heater 13 heats the tobacco rod 21. The user may thus inhale the aerosol cooled down to a suitable temperature.

A length or a diameter of the second segment may be determined in various ways according to a shape of the cigarette 2. For example, a desirable length of the second segment may be adopted in a range of 7 mm to 20 mm. Desirably, the length of the second segment may be about 14 mm. However, embodiments are not limited thereto.

The second segment may be manufactured by weaving a polymer fiber. In this case, a flavoring liquid may be applied to a fiber made of a polymer. Alternatively, the second segment may be manufactured by weaving a separate fiber to which flavoring liquid is applied and the fiber made of the polymer together. Alternatively, the second segment may be formed of a crimped polymer sheet.

For example, the polymer may be prepared with a material selected from a group including polyethylene (PE), polypropylene (PP), polyvinyl chloride (PVC), polyethylene terephthalate (PET), polylactic acid (PLA), cellulose acetate (CA), and aluminum foil.

As the second segment is formed of the woven polymer fiber or the crimped polymer sheet, the second segment may include a single channel or a plurality of channels extending in a longitudinal direction. A channel used herein may refer to a path through which a gas (e.g., air or aerosol) passes.

For example, the second segment formed of the crimped polymer sheet may be formed of a material having a thickness between about 5 μm and about 300 μm, for example, between about 10 μm and about 250 μm. In addition, a total surface area of the second segment may be between about 300 square millimeters per millimeter (mm²/mm) and about 1000 mm² /mm. Furthermore, an aerosol cooling element may be formed from a material having a specific surface area between about 10 square millimeters per milligram (mm²/mg) and about 100 mm² /mg.

The second segment may include a thread containing a volatile flavor ingredient. The volatile flavor ingredient may be menthol but is not limited thereto. For example, the thread may be filled with an amount of menthol sufficient to provide at least 1.5 mg of menthol to the second segment.

The third segment of the filter rod 22 may be a cellulose acetate filter. A desirable length of the third segment may be adopted in a range of 4 mm to 20 mm. For example, the length of the third segment may be about 12 mm. However, embodiments are not limited thereto.

The third segment may be manufactured so that a flavor may be generated by spraying a flavoring liquid onto the third segment in a process of manufacturing the third segment. Alternatively, a separate fiber to which flavoring liquid is applied may be inserted into the third segment. An aerosol generated in the tobacco rod 21 may be cooled when passing through the second segment of the filter rod 22, and the cooled aerosol may pass through the third segment into a user. Accordingly, when a flavoring element is added to the third segment, a durability of the flavor to be delivered to the user may be enhanced.

In addition, the filter rod 22 may include at least one capsule 23. Here, the capsule 23 may perform a function of generating a flavor or a function of generating an aerosol. For example, the capsule 23 may have a structure in which a liquid containing a fragrance is wrapped with a film. The capsule 23 may have a spherical or cylindrical shape but is not limited thereto.

Referring to FIG. 3, a cigarette 3 may further include a front end plug 33. The front end plug 33 may be placed on one side of a tobacco rod 31 facing a filter rod 32. The front end plug 33 may prevent the tobacco rod 31 from being released to the outside and may prevent liquefied aerosol from flowing from the tobacco rod 31 into an aerosol generating device (e.g., the aerosol generating device 1 of FIGS. 1A to 1D) during smoking.

The filter rod 32 may include a first segment 321 and a second segment 322. Here, the first segment 321 may correspond to the first segment of the filter rod 22 of FIG. 2, and the second segment 322 may correspond to the third segment of the filter rod 22 of FIG. 2.

A diameter and a total length of the cigarette 3 may correspond to the diameter and the total length of the cigarette 2 of FIG. 2. For example, a length of the front end plug 33 may be about 7 mm, a length of the tobacco rod 31 may be about 15 mm, a length of the first segment 321 may be about 12 mm, and a length of the second segment 322 may be about 14 mm. However, embodiments are not limited thereto.

The cigarette 3 may be wrapped with at least one wrapper 35. The wrapper 35 may have at least one hole formed therein through which external air may be introduced or internal gas may flow out. For example, the front end plug 33 may be wrapped with a first wrapper 351, the tobacco rod 31 may be wrapped with a second wrapper 352, the first segment 321 may be wrapped with a third wrapper 353, and the second segment 322 may be wrapped with a fourth wrapper 354. In addition, the cigarette 3 may be entirely wrapped again with a fifth wrapper 355.

In addition, at least one perforation 36 may be formed in the fifth wrapper 355. For example, the perforation 36 may be formed in an area surrounding the tobacco rod 31. However, embodiments are not limited thereto. The perforation 36 may serve to transfer heat formed by the heater 13 (or the coil 13a and the susceptor 13b) shown in FIGS. 1A to 1D to an inside of the tobacco rod 31.

In addition, the second segment 322 may include at least one capsule 34. Here, the capsule 34 may perform a function of generating a flavor or a function of generating an aerosol. For example, the capsule 34 may have a structure in which a liquid containing a fragrance is wrapped with a film. The capsule 34 may have a spherical or cylindrical shape but is not limited thereto.

The first wrapper 351 may be a combination of general filter wrapping paper and a metal foil such as an aluminum foil. For example, a total thickness of the first wrapper 351 may be in a range of 45 μm to 55 μm, and desirably, may be 50.3 μm. Furthermore, a thickness of the metal foil of the first wrapper 351 may be in a range of 6 μm to 7 μm, and desirably, may be 6.3 μm. In addition, a basis weight of the first wrapper 351 may be in a range of 50 g/m2 to 55 g/m2, and desirably, may be 53 g/m2 .

The second wrapper 352 and the third wrapper 353 may be manufactured from general filter wrapping paper. For example, the second wrapper 352 and the third wrapper 353 may be porous wrapping paper or non-porous wrapping paper.

For example, a porosity of the second wrapper 352 may be 35000 CU. However, embodiments are not limited thereto. Furthermore, a thickness of the second wrapper 352 may be in a range of 70 μm to 80 μm, and desirably, may be 78 μm. In addition, a basis weight of the second wrapper 352 may be in a range of 20 g/m 2 to 25 g/m2, and desirably, may be 23.5 g/m2 .

For example, a porosity of the third wrapper 353 may be 24000 CU. However, embodiments are not limited thereto. Furthermore, a thickness of the third wrapper 353 may be in a range of 60 μm to 70 μm, and desirably, may be 68 μm. In addition, a basis weight of the third wrapper 353 may be in a range of 20 g/m2 to 25 g/m2, and desirably, may be 21 g/m2.

The fourth wrapper 354 may be manufactured from PLA laminated paper. Here, the PLA laminated paper may refer to three-ply paper including a paper layer, a PLA layer, and a paper layer. For example, a thickness of the fourth wrapper 354 may be in a range of 100 μm to 120 μm, and desirably, may be 110 μm. In addition, a basis weight of the fourth wrapper 354 may be in a range of 80 g/m² to 100 g/m², and desirably, may be 88 g/m².

The fifth wrapper 355 may be manufactured from sterile paper (e.g., MFW). Here, the sterile paper (e.g., MFW) may refer to paper specially made such that the paper has enhanced tensile strength, water resistance, smoothness, or the like, compared to general paper. For example, a basis weight of the fifth wrapper 355 may be in a range of 57 g/m² to 63 g/m², and desirably, may be 60 g/m². Furthermore, a thickness of the fifth wrapper 355 may be in a range of 64 μm to 70 μm, and desirably, may be 67 μm.

The fifth wrapper 355 may have a predetermined material internally added thereto. The predetermined material may be, for example, silicon. However, embodiments are not limited thereto. Silicon may have properties, such as, for example, heat resistance which is characterized by less change by temperature, oxidation resistance which refers to resistance to oxidation, resistance to various chemicals, water repellency against water, or electrical insulation. However, silicon may not necessarily be used, and any material having such properties described above may be applied to (or used to coat) the fifth wrapper 355 without limitation.

The front end plug 33 may be manufactured from cellulose acetate. For example, the front end plug 33 may be manufactured by adding a plasticizer (e.g., triacetin) to cellulose acetate tow. A mono denier of a filament of the cellulose acetate tow may be in a range of 1.0 to 10.0, and desirably, may be in a range of 4.0 to 6.0. More desirably, a mono denier of a filament of the front end plug 33 may be 5.0. In addition, a cross section of the filament of the front end plug 33 may be Y-shaped. A total denier of the front end plug 33 may be in a range of 20000 to 30000, and desirably, may be in a range of 25000 to 30000. More desirably, the total denier of the front end plug 33 may be 28000.

In addition, as needed, the front end plug 33 may include at least one channel, and a cross-sectional shape of the channel may be manufactured in various ways.

The tobacco rod 31 may correspond to the tobacco rod 21 described above with reference to FIG. 2. Thus, a detailed description of the tobacco rod 31 is omitted hereinafter.

The first segment 321 may be manufactured from cellulose acetate. For example, the first segment may be a tubular structure including a hollow therein. The first segment 321 may be manufactured by adding a plasticizer (e.g., triacetin) to cellulose acetate tow. For example, a mono denier and a total denier of the first segment 321 may be the same as the mono denier and the total denier of the front end plug 33, respectively.

The second segment 322 may be manufactured from cellulose acetate. A mono denier of a filament of the second segment 322 may be in a range of 1.0 to 10.0, and desirably, may be in a range of 8.0 to 10.0. More desirably, the mono denier of the filament of the second segment 322 may be 9.0. In addition, a cross section of the filament of the second segment 322 may be Y-shaped. A total denier of the second segment 322 may be in a range of 20000 to 30000, and desirably, may be 25000.

FIG. 4 is a block diagram of an aerosol generating device 400 according to another embodiment.

According to an embodiment, the aerosol generating device 400 (e.g., the aerosol generating device 1 of FIGS. 1A to 1D) may include a controller 410, a sensing unit 420, an output unit 430, a battery 440, a heater 450, a user input unit 460, a memory 470, and a communication unit 480. However, an internal structure of the aerosol generating device 100 is not limited to what is shown in FIG. 1. It is to be understood by one of ordinary skill in the art to which the present embodiment pertains that some of the components shown in FIG. 4 may be omitted or new components may be added according to the design of the aerosol generating device 400.

The sensing unit 420 may sense a state of the aerosol generating device 400 or a state of an environment around the aerosol generating device 400 and transmit sensing information obtained through the sensing to the controller 410. Based on the sensing information, the controller 410 may control the aerosol generating device 400 to perform various functions such as controlling an operation of the heater 450, restricting smoking, determining whether an aerosol generating article (e.g., the cigarette 2 of FIGS. 1A to 1D and FIG. 2, the cigarette 3 of FIG. 3, or a cartridge) is inserted, displaying a notification, and the like.

The sensing unit 420 may include at least one of a temperature sensor 422, an insertion detection sensor 424, and a puff sensor 426. However, embodiments are not limited thereto.

The temperature sensor 422 may sense a temperature at which the heater 450 (or an aerosol generating material) is heated. The aerosol generating device 400 may include a separate temperature sensor for sensing a temperature of the heater 450, or the heater 450 itself may perform a function as a temperature sensor. Alternatively, the temperature sensor 422 may be arranged around the battery 440 to monitor a temperature of the battery 440.

The insertion detection sensor 424 may sense whether the aerosol generating article is inserted and/or removed. The insertion detection sensor 424 may include, for example, at least one of a film sensor, a pressure sensor, a light sensor, a resistive sensor, a capacitive sensor, an inductive sensor, or an infrared sensor, which may sense a signal change by the insertion and/or removal of the aerosol generating article.

The puff sensor 426 may sense a puff from a user based on various physical changes in an airflow path or airflow channel. For example, the puff sensor 426 may sense the puff from the user based on any one of a temperature change, a flow change, a voltage change, and a pressure change.

The sensing unit 420 may further include at least one of a temperature/humidity sensor, an atmospheric pressure sensor, a magnetic sensor, an acceleration sensor, a gyroscope sensor, a position sensor (e.g., a global positioning system (GPS)), a proximity sensor, or a red, green, blue (RGB) sensor (e.g., an illuminance sensor), in addition to the sensors 422 through 426 described above. A function of each sensor may be intuitively inferable from its name by one of ordinary skill in the art, and thus, a detailed description thereof is omitted herein.

The output unit 430 may output information on a state of the aerosol generating device 400 and provide the information to the user. The output unit 430 may include at least one of a display 432, a haptic portion 434, or a sound outputter 436. However, embodiments are not limited thereto. When the display 432 and a touchpad are provided in a layered structure to form a touchscreen, the display 432 may be used as not only an output device but also an input device.

The display 432 may visually provide the information on the aerosol generating device 400 to the user. The information on the aerosol generating device 400 may include, for example, a charging/discharging state of the battery 440 of the aerosol generating device 400, a preheating state of the heater 450, an insertion/removal state of the aerosol generating article, a limited usage state (e.g., an abnormal article detected) of the aerosol generating device 400, or the like, and the display 432 may externally output the information. The display 432 may be, for example, a liquid-crystal display (LCD) panel, an organic light-emitting diode (OLED) panel, or the like. The display 432 may also be in the form of a light-emitting diode (LED) device (or element).

The haptic portion 434 may provide the information about the aerosol generating device 400 to the user in a haptic manner by converting an electrical signal into a mechanical stimulus or an electrical stimulus. The haptic portion 434 may include, for example, a motor, a piezoelectric element, or an electrical stimulation device.

The sound outputter 436 may provide the information about the aerosol generating device 400 to the user in an auditory manner. For example, the sound outputter 436 may convert an electrical signal into a sound signal and externally output the sound signal.

The battery 440 may supply power to be used to operate the aerosol generating device 400. The battery 440 may supply power to heat the heater 450. In addition, the battery 440 may supply power required for operations of the other components (e.g., the sensing unit 420, the output unit 430, the user input unit 460, the memory 470, and the communication unit 480) included in the aerosol generating device 400. The battery 440 may be a rechargeable battery or a disposable battery. The battery 440 may be, for example, a lithium polymer (LiPoly) battery. However, embodiments are not limited thereto.

The heater 450 may receive power from the battery 440 to heat the aerosol generating material. Although not shown in FIG. 4, the aerosol generating device 400 may further include a power conversion circuit (e.g., a direct current (DC)-to-DC (DC/DC) converter) that converts power of the battery 440 and supplies the power to the heater 450. In addition, when the aerosol generating device 400 generates an aerosol in an induction heating manner, the aerosol generating device 400 may further include a DC-to-alternating current (AC) (DC/AC) converter that converts DC power of the battery 440 into AC power.

The controller 410, the sensing unit 420, the output unit 430, the user input unit 460, the memory 470, and the communication unit 480 may receive power from the battery 440 to perform functions. Although not shown in FIG. 4, the aerosol generating device 400 may further include a power conversion circuit, for example, a low dropout (LDO) circuit or a voltage regulator circuit, which converts power of the battery 440 and supplies the power to respective components.

In an embodiment, the heater 450 may be formed of any suitable electrically resistive material. The suitable electrically resistive material may be, for example, a metal or a metal alloy including titanium, zirconium, tantalum, platinum, nickel, cobalt, chromium, hafnium, niobium, molybdenum, tungsten, tin, gallium, manganese, iron, copper, stainless steel, nichrome, or the like. However, embodiments are not limited thereto. In addition, the heater 450 may be implemented as a metal heating wire, a metal heating plate on which an electrically conductive track is arranged, a ceramic heating element, or the like. However, embodiments are not limited thereto.

In another embodiment, the heater 450 may be an induction heater. For example, the heater 450 may include a susceptor that heats the aerosol generating material by generating heat through a magnetic field applied by a coil.

In an embodiment, the heater 450 may include a plurality of heaters. For example, the heater 450 may include a first heater for heating a cigarette and a second heater for heating a liquid.

The user input unit 460 may receive information input from the user or may output information to the user. For example, the user input unit 460 may include a keypad, a dome switch, a touchpad (e.g., a contact capacitive type, a pressure resistive film type, an infrared sensing type, a surface ultrasonic conduction type, an integral tension measurement type, a piezo effect method, etc.), a jog wheel, a jog switch, or the like. However, embodiments are not limited thereto. In addition, although not shown in FIG. 4, the aerosol generating device 400 may further include a connection interface, such as a universal serial bus (USB) interface, and may be connected to another external device through the connection interface, such as a USB interface, to transmit and receive information or to charge the battery 440.

The memory 470 is hardware for storing various pieces of data processed in the aerosol generating device 400 and may store data processed by the controller 410 and data to be processed by the controller 410. The memory 470 may include at least one type of storage medium of a flash memory type memory, a hard disk type memory, a multimedia card micro type memory, a card type memory (e.g., an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, or an optical disk. The memory 470 may store an operating time of the aerosol generating device 400, a maximum number of puffs, a current number of puffs, at least one temperature profile (or heating profile), data associated with a smoking pattern of the user, and the like.

The communication unit 480 may include at least one component for a communication with another electronic device. For example, the communication unit 480 may include a short-range wireless communication unit 482 and a wireless communication unit 484.

The short-range wireless communication unit 482 may include a Bluetooth communication unit, a Bluetooth low energy (BLE) communication unit, a near field communication unit, a wireless local area network (WLAN) (e.g., Wi-Fi) communication unit, a Zigbee communication unit, an infrared data association (IrDA) communication unit, a Wi-Fi Direct (WFD) communication unit, an ultra-wideband (UWB) communication unit, an Ant+communication unit, and the like. However, embodiments are not limited thereto.

The wireless communication unit 484 may include a cellular network communication unit, an Internet communication unit, a computer network (e.g., a local area network (LAN) or a wide-area network (WAN)) communication unit, or the like. However, embodiments are not limited thereto. The wireless communication unit 484 may use subscriber information (e.g., international mobile subscriber identity (IMSI)) to identify and authenticate the aerosol generating device 400 in a communication network.

The controller 410 may control the overall operation of the aerosol generating device 400. In an embodiment, the controller 410 may include at least one processor. The processor may be implemented as an array of a plurality of logic gates or as a combination of a general-purpose microprocessor and a memory in which a program executable by the microprocessor is stored. In addition, it is to be understood by one of ordinary skill in the art to which the present embodiment pertains that the processor may be implemented in other types of hardware.

The controller 410 may control the temperature of the heater 450 by controlling the supply of power from the battery 440 to the heater 450. For example, the controller 410 may control the supply of power by controlling switching of a switching element between the battery 440 and the heater 450. In another example, a direct heating circuit may control the supply of power to the heater 450 according to a control command from the controller 410.

The controller 410 may analyze a sensing result obtained by the sensing unit 420 and control subsequent processes accordingly. For example, the controller 410 may control power to be supplied to the heater 450 to start or end an operation of the heater 450, based on the sensing result obtained by the sensing unit 420. In another example, the controller 410 may control an amount of power to be supplied to the heater 450 and a time for which the power is to be supplied such that the heater 450 may be heated up to a predetermined temperature or maintained at a desired temperature, based on the sensing result obtained by the sensing unit 420.

The controller 410 may control the output unit 430 based on the sensing result obtained by the sensing unit 420. For example, when a number of puffs counted through the puff sensor 426 reaches a preset number, the controller 410 may inform the user that the aerosol generating device 400 is to be ended soon, through at least one of the display 432, the haptic portion 434, and the sound outputter 436.

In an embodiment, the controller 410 may control a power supply time and/or a power supply amount for the heater 450 according to a state of the aerosol generating article sensed by the sensing unit 420. For example, when the aerosol generating article is in an over-humidified state, the controller 410 may control a power supply time for an inductive coil to increase a preheating time compared to a case in which the aerosol generating article is in a general state.

An embodiment may also be implemented in the form of a recording medium including instructions executable by a computer, such as a program module executable by the computer. A computer-readable medium may be any available medium that can be accessed by a computer and includes a volatile medium, a non-volatile medium, a removable medium, and a non-removable medium. In addition, the computer-readable medium may include both a computer storage medium and a communication medium. The computer storage medium includes all of a volatile medium, a non-volatile medium, a removable medium, and a non-removable medium implemented by any method or technology for storage of information such as computer-readable instructions, data structures, program modules or other data. The communication medium typically includes computer-readable instructions, data structures, other data in modulated data signals such as program modules, or other transmission mechanisms, and includes any information transfer medium.

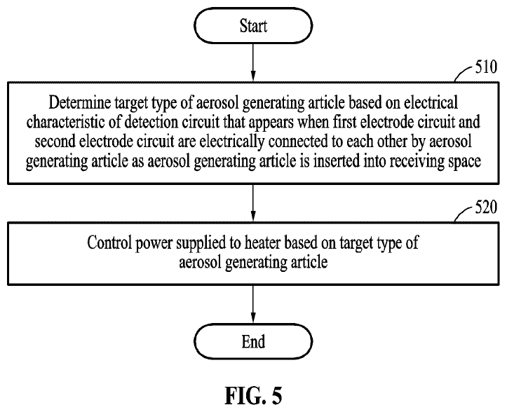

FIG. 5 is a flowchart illustrating a control method of an aerosol generating device, according to various embodiments.

Operations 510 and 520 described below may be performed by an aerosol generating device (e.g., the aerosol generating device 1 of FIGS. 1A to 1D or the aerosol generating device 400 of FIG. 4). The aerosol generating device may include at least some of the components of the aerosol generating device 1 of FIGS. 1A to 1D or the aerosol generating device 400 of FIG. 4. For example, the aerosol generating device may include a controller (e.g., the controller 12 of FIGS. 1A to 1D or the controller 410 of FIG. 4), a heater (e.g., the heater 13 or the vaporizer 14 of FIGS. 1A to 1C, the coil 13a of FIG. 1D, or the heater 450 of FIG. 4), and a power supply unit (e.g., the battery 11 of FIGS. 1A to 1D or the battery 440 of FIG. 4).

The aerosol generating device according to an embodiment may include a detection circuit including a first electrode circuit and a second electrode circuit arranged not to be electrically connected to each other inside a receiving space (e.g., the cavity 13c of FIG. 1D) into which an aerosol generating article (e.g., the cigarette 2 of FIGS. 1A to 1D and FIG. 2 or the cigarette 3 of FIG. 3) is inserted. For example, when no aerosol generating article is inserted, the detection circuit may form an open circuit connected to the controller.

In operation 510, the controller of the aerosol generating device may determine a target type of the aerosol generating article based on an electrical characteristic of the detection circuit that is present when the first electrode circuit and the second electrode circuit are electrically connected to each other by the aerosol generating article as the aerosol generating article is inserted into the receiving space.

According to an embodiment, the controller of the aerosol generating device may determine the target type of the aerosol generating article based on the electrical characteristic of the detection circuit that is present when a first electrode of the first electrode circuit and a second electrode of the second electrode circuit are electrically connected to each other via a conductive material of the aerosol generating article.

According to an embodiment, the first electrode circuit and the second electrode circuit may be electrically connected via a conductive material of the aerosol generating article, thereby forming a closed circuit including the detection circuit and the controller. The detection circuit may be provided with power from the power supplier by forming a closed circuit. The controller may determine the target type of the aerosol generating article based on the electrical characteristic that is present when the detection circuit receives power.

According to an embodiment, the electrical characteristic of the detection circuit (or an electrical characteristic that is present with respect to the detection circuit) may include a size, a rise rate, and the like of an output signal of the detection circuit due to the power supplied from the power supply unit. The controller may determine the electrical characteristic of the detection circuit by measuring the output signal of the detection circuit.

According to an embodiment, the aerosol generating device may store information on a correlation between the electrical characteristic of the detection circuit and a type of the aerosol generating article. For example, the aerosol generating device may store a lookup table representing information on a plurality of types of aerosol generating articles, each of which corresponds to a plurality of electrical characteristics (e.g., a value of the size of an output signal, a range of the size of the output signal, a value of the rise rate per unit time of the output signal, or a range of the rise rate per unit time of the output signal) of the detection circuit.

The controller of the aerosol generating device may determine a type of the aerosol generating article corresponding to the determined electrical characteristic of the detection circuit to be the target type, based on the information (e.g., a lookup table) on the correlation between the electrical characteristic of the detection circuit and the type of the aerosol generating article.

In operation 520, the controller of the aerosol generating device may control power supplied to the heater based on the target type of the aerosol generating article.

The aerosol generating device may store one or more profiles (a temperature profile or a heating profile) for controlling the power supplied to the heater in a memory (e.g., the memory 470 of FIG. 4).

The one or more profiles stored in the aerosol generating device may each correspond to a particular type of the aerosol generating article. Each profile may include information for appropriately controlling the power supplied to the heater when a corresponding type of aerosol generating article is used. For example, the information on the correlation between the electrical characteristic of the detection circuit and the type of the aerosol generating article may include information on a profile corresponding to each type of the aerosol generating article.

According to an embodiment, the controller of the aerosol generating device may determine, from among one or more profiles, a target temperature profile corresponding to the target type of the aerosol generating article.

According to an embodiment, the controller of the aerosol generating device may control the power supplied to the heater based on the target temperature profile.

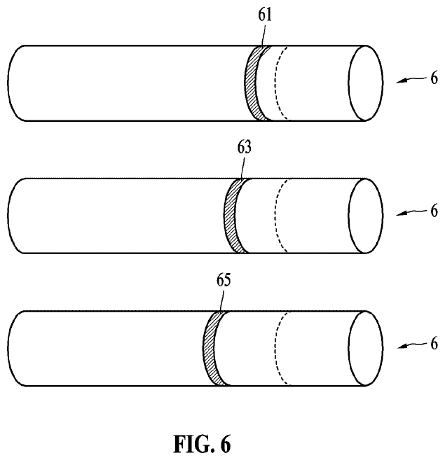

FIG. 6 is a diagram illustrating a conductive material of an aerosol generating article, according to an embodiment.

According to an embodiment, a first electrode circuit of an aerosol generating device (e.g., the aerosol generating device 1 of FIGS. 1A to 1D or the aerosol generating device 400 of FIG. 4) may include one first electrode, and a second electrode circuit of the aerosol generating device may include one second electrode. According to an embodiment, an aerosol generating article 6 (e.g., the cigarette 2 of FIGS. 1A to 1D and FIG. 2 or the cigarette 3 of FIG. 3) may include a conductive material having a resistance value corresponding to a target type of the aerosol generating article 6 and surrounding a periphery of an outer circumferential surface. For example, the conductive material may be provided on a wrapper of the aerosol generating article 6 (e.g., the wrapper 24 of FIG. 2 or the wrapper 35 of FIG. 3). The aerosol generating article 6 may include a conductive material that makes simultaneous contact with the first electrode and the second electrode when inserted into the aerosol generating device. In this case, the aerosol generating device may determine a target type of the aerosol generating article 6 based on an electrical characteristic of the detection circuit that is present according to the resistance value of the conductive material.

According to an embodiment, the first electrode circuit of the aerosol generating device may include one or more first electrodes arranged in a direction in which the aerosol generating article 6 is inserted, and the second electrode circuit may include one or more second electrodes arranged in a direction in which the aerosol generating article 6 is inserted. According to an embodiment, the aerosol generating article 6 may include the conductive material surrounding the periphery of the outer circumferential surface at a position corresponding to the target type of the aerosol generating article 6. For example, the conductive material may be provided on a wrapper of the aerosol generating article 6 (e.g., the wrapper 24 of FIG. 2 or the wrapper 35 of FIG. 3). Hereinafter, a description of a case in which the conductive material is arranged at a position corresponding to the type of the aerosol generating article 6 is given with reference to FIG. 6.

The conductive material may be placed at different positions along the direction in which the aerosol generating article 6 is inserted into the aerosol generating device. A first position 61, a second position 63, and a third position 65 on the outer circumferential surface of the aerosol generating article 6, on which the conductive material may be placed, may each correspond to the target type of the aerosol generating article 6.

According to an embodiment, the conductive material positioned at the first position 61, the second position 63, or the third position 65 may be manufactured to have a determined width and resistance value. For example, the conductive material may be wrapped or printed in the form of a band at the first location 61, the second location 63, or the third location 65 of the aerosol generating article 6. For example, the conductive material may be wrapped around the aerosol generating article 6 in the form of a conductive tape.

According to an embodiment, the first position 61, the second position 63, and the third position 65 at which the conductive material is placed may respectively correspond to a target type according to one of cut tobacco (or shredded tobacco), granules, and liquid, which are types of a medium of the aerosol generating article 6.

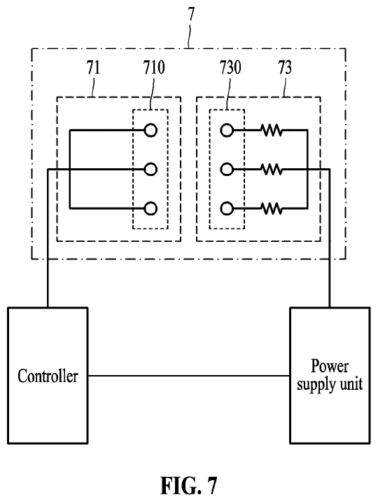

FIG. 7 is a diagram illustrating a detection circuit of an aerosol generating device, according to an embodiment.

According to an embodiment, a detection circuit 7 of an aerosol generating device (e.g., the aerosol generating device 1 of FIGS. 1A to 1D or the aerosol generating device 400 of FIG. 4) may be connected to a controller (e.g., the controller 12 of FIGS. 1A to 1D or the controller 410 of FIG. 4) and a power supply unit (e.g., the battery 11 of FIGS. 1A to 1D or the battery 440 of FIG. 4). The detection circuit 7 may include a first electrode circuit 71 and a second electrode circuit 73.

According to an embodiment, the first electrode circuit 71 may include one or more first electrodes 710 arranged in a direction in which an aerosol generating article (e.g., the cigarette 2 of FIGS. 1A to 1D and FIG. 2 or the cigarette 3 of FIG. 3) is inserted. The second electrode circuit 73 may include one or more second electrodes 730 arranged in a direction in which the aerosol generating article is inserted.

According to an embodiment, the second electrode circuit 73 may include resistors having different resistance values respectively connected to the one or more second electrodes 730.

According to an embodiment, the second electrode circuit 73 may include elements that are respectively connected to the one or more second electrodes 730 so that electrical characteristics of the detection circuit 7 may be distinguished. For example, the one or more of the second electrodes 730 may be respectively connected to capacitors having different capacitance values or inductors having different inductance values. For example, the one or more of the second electrodes 730 may be respectively connected to different types of elements or combinations thereof (e.g., a resistor and a capacitor, a resistor and an inductor, or a capacitor and an inductor). The elements connected to the one or more second electrodes 730 may each have a characteristic value (e.g., a resistance value, a capacitance value, and an inductance value) that has sufficient differences to distinguish the electrical characteristics that are present with respect to the detection circuit 7.

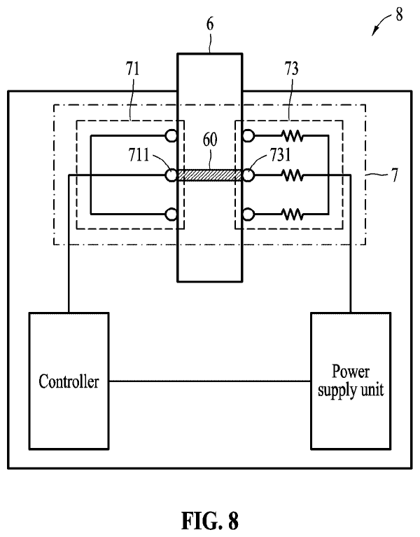

FIG. 8 is a diagram illustrating an operation of an aerosol generating device, according to an embodiment.

According to an embodiment, an aerosol generating device 8 (e.g., the aerosol generating device 1 of FIGS. 1A to 1D or the aerosol generating device 400 of FIG. 4) may include a detection circuit 7.

According to an embodiment, when the aerosol generating article 6 (e.g., the cigarette 2 of FIGS. 1A to 1D and FIG. 2 or the cigarette 3 of FIG. 3) is inserted into a receiving space of the aerosol generating device 8, a first electrode 711 of one or more first electrodes of the first electrode circuit 71 and a second electrode 731 of one or more second electrodes of the second electrode circuit 73 may be electrically connected to each other via the conductive material 60 of the aerosol generating article 6. The conductive material 60 of the aerosol generating article 6 may be in contact with the first electrode 711 and the second electrode 731 simultaneously.

According to an embodiment, when the first electrode circuit 71 and the second electrode circuit 73 are electrically connected to each other by the conductive material 60 of the aerosol generating article 6 as the aerosol generating article 6 is inserted into the receiving space of the aerosol generating device 8, a controller (e.g., the controller 12 of FIGS. 1A to 1D or the controller 410 of FIG. 4) of the aerosol generating device 8 may receive power from a power supply unit (e.g., the battery 11 of FIGS. 1A to 1D or the battery 440 of FIG. 4) and the aerosol generating device 8 may be powered on. That is, when the aerosol generating article 6 is inserted while the aerosol generating device 8 is powered off, the power may be turned on without a user input.

According to an embodiment, when the aerosol generating device 8 is powered on, the control unit of the aerosol generating device 8 may determine a target type of the aerosol generating article 6.

According to an embodiment, when the aerosol generating device 8 is powered on simply by an insertion of the aerosol generating article 6 without a separate user input, the aerosol generating device 8 may supply power to a heater based on a target temperature profile suitable for (or corresponding to) the target type of the aerosol generating article 6. The controller of the aerosol generating device 8 may detect that, when the aerosol generating article 6 is removed from the aerosol generating device 8, an electrical connection between the first electrode 711 and the second electrode 731 is disconnected, and may automatically turn off the power based on the disconnection of the electrical connection between the first electrode 711 and the second electrode 731.

The methods according to the embodiments may be recorded in non-transitory computer-readable media including program instructions to implement various operations of the embodiments. The media may also include the program instructions, data files, data structures, and the like alone or in combination. The program instructions recorded on the media may be those specially designed and constructed for the purposes of embodiments, or they may be of the kind well-known and available to one of ordinary skill in the computer software arts. Examples of non-transitory computer-readable media include magnetic media such as hard disks, floppy disks, and magnetic tape; optical media such as CD-ROM discs and DVDs; magneto-optical media such as optical discs; and hardware devices that are specially configured to store and perform program instructions, such as read-only memory (ROM), random-access memory (RAM), flash memory, and the like. Examples of program instructions include both machine code, such as those produced by a compiler, and files containing high-level code that may be executed by the computer using an interpreter. The above-described hardware devices may be configured to act as one or more software modules in order to perform the operations of the examples, or vice versa.

The software may include a computer program, a piece of code, an instruction, or one or more combinations thereof, to independently or collectively instruct or configure the processing device to operate as desired. Software and/or data may be embodied permanently or temporarily in any type of machine, component, physical or virtual equipment, computer storage medium or device, or in a propagated signal wave for the purpose of being interpreted by the processing device or providing instructions or data to the processing device. The software may also be distributed over network-coupled computer systems so that the software is stored and executed in a distributed fashion. The software and data may be stored by one or more non-transitory computer-readable recording mediums.

While the embodiments are described with reference to a limited number of drawings, it will be apparent to one of ordinary skill in the art that various alterations and modifications in form and details may be made in these embodiments without departing from the spirit and scope of the claims and their equivalents. For example, suitable results may be achieved if the described techniques are performed in a different order and/or if components in a described system, architecture, device, or circuit are combined in a different manner and/or replaced or substituted by other components or their equivalents.

Therefore, other implementations, other embodiments, and equivalents to the claims are also within the scope of the following claims.

1. An aerosol generating device comprising:
a detection circuit comprising a first electrode circuit and a second electrode circuit arranged not to be electrically connected to each other inside a receiving space into which an aerosol generating article is inserted;
a heater configured to heat the aerosol generating article;
a controller; and
a power supply unit configured to supply power to the controller,
wherein the controller is configured to perform:
determining a target type of the aerosol generating article based on an electrical characteristic of the detection circuit that is present when the first electrode circuit and the second electrode circuit are electrically connected to each other by the aerosol generating article as the aerosol generating article is inserted into the receiving space; and
controlling power supplied to the heater based on the target type of the aerosol generating article.

2. The aerosol generating device of claim 1, wherein
the first electrode circuit comprises one or more first electrodes arranged in a direction in which the aerosol generating article is inserted, and
the second electrode circuit comprises one or more second electrodes arranged in a direction in which the aerosol generating article is inserted.

3. The aerosol generating device of claim 2, wherein the second electrode circuit comprises:
resistors having different resistance values respectively connected to the one or more second electrodes.

4. The aerosol generating device of claim 1, wherein the aerosol generating article comprises:
a conductive material surrounding a periphery of an outer circumferential surface at a position corresponding to the target type of the aerosol generating article.

5. The aerosol generating device of claim 4, wherein the determining of the target type of the aerosol generating article comprises:
determining the target type of the aerosol generating article based on the electrical characteristic of the detection circuit that is present when a first electrode of the first electrode circuit and a second electrode of the second electrode circuit are electrically connected to each other via the conductive material of the aerosol generating article.

6. The aerosol generating device of claim 1, wherein the controlling of the power supplied to the heater based on the target type of the aerosol generating article comprises:
determining, from among one or more temperature profiles, a target temperature profile corresponding to the target type of the aerosol generating article; and
controlling the power supplied to the heater based on the target temperature profile.

7. The aerosol generating device of claim 1, wherein,
when the first electrode circuit and the second electrode circuit are electrically connected to each other by the aerosol generating article as the aerosol generating article is inserted into the receiving space, the controller is configured to receive power from the power supply unit and the aerosol generating device is configured to be powered on.

8. The aerosol generating device of claim 1,
wherein the first electrode circuit comprises a first electrode and the second electrode circuit comprises a second electrode, and
wherein the aerosol generating article comprises a conductive material having a resistance value corresponding to the target type of the aerosol generating article and surrounding a periphery of an outer circumferential surface.

9. A control method of an aerosol generating device, the method being performed by the aerosol generating device,
wherein the aerosol generating device comprises:
a detection circuit comprising a first electrode circuit and a second electrode circuit arranged not to be electrically connected to each other inside a receiving space into which an aerosol generating article is inserted;
a heater configured to heat the aerosol generating article;
a controller; and
a power supply unit configured to supply power to the controller, and wherein the method comprises:
determining a target type of the aerosol generating article based on an electrical characteristic of the detection circuit that is present when the first electrode circuit and the second electrode circuit are electrically connected to each other by the aerosol generating article as the aerosol generating article is inserted into the receiving space; and
controlling power supplied to the heater based on the target type of the aerosol generating article.

10. An aerosol generating device comprising:
a detection circuit comprising a first electrode circuit and a second electrode circuit arranged not to be electrically connected to each other inside a receiving space into which an aerosol generating article is inserted;
a heater configured to heat the aerosol generating article;
a controller; and
a power supply unit configured to supply power to the controller,
wherein, when the first electrode circuit and the second electrode circuit are electrically connected to each other by the aerosol generating article as the aerosol generating article is inserted into the receiving space, the controller is configured to receive power from the power supply unit and the aerosol generating device is configured to be powered on.
